(19) United States
(12) Patent Application Publication
(10) Pub. No.: US 2009/0237195 A1
(43) Pub. Date: Sep. 24, 2009

(54) Center-tapped transformer

(76) Inventors: Zhong Zeng, Taipei (TW); Xuezheng Ding, Taipei (TW); Limin Du, Taipei (TW); Xin Guo, Taipei (TW); Zhihong Ye, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,476

(22) Filed: Sep. 18, 2008

(30) Foreign Application Priority Data
Mar. 21, 2008 (CN) 200810026969.0

(51) Int. Cl. H01F 27/30

(52) U.S. Cl. 336/196

(57) ABSTRACT

A center-tapped transformer includes a spool that defines a spool axis and that has an axially extending first spool part and a second spool part extending coaxially from the first spool part, a primary winding unit that surrounds the first and second spool parts, first and second secondary winding units that are disposed on one side of the primary winding unit and that surround the first and second spool parts, respectively, and an isolating unit that is disposed between the first and second secondary winding units to separate the first and second secondary winding units from each other.

### CROSS-REFERENCE TO RELATED APPLICATION

This application claims priority of Chinese application no. 200810026969.0, filed on Mar. 21, 2008.

### BACKGROUND OF THE INVENTION

1. Field of the Invention

The invention relates to a transformer, more particularly to a center-tapped transformer.

2. Description of the Related Art

Most electronic apparatus include a transformer as a core component to satisfy power transformation requirements. A transformer has an inherent leakage inductance. In particular, some magnetic lines of force generated when electricity is supplied to a primary winding do not pass through a secondary winding and thus do not generate corresponding electric current in the secondary winding. The leakage inductance is a measure of inductance of such magnetic lines of force (also called leakage flux).

In general, the leakage inductance of a transformer should be kept as small as possible. However, in some applications, the transformer is required to have a certain level of leakage inductance, such as when the leakage inductance is employed as a resonance inductance, or when the leakage inductance of a common-mode inductor is employed as a differential-mode inductance, etc.

FIG. 1 is a sectional diagram of a conventional center-tapped transformer 100, which includes a tubular spool 102, a primary winding 104, a first secondary winding 106, a second secondary winding 108, a first isolating unit 110, a second isolating unit 112, and an iron core (not shown). The spool 102 is formed with a hollow portion 114 for extension of the iron core therethrough. The primary winding 104 is wound on the spool 102. The first secondary winding 106 is wound around the primary winding 104 and is spaced apart there from by the ring-shaped first isolating unit 110. The second secondary winding 108 is wound around the first secondary winding 106 and is spaced apart therefrom by the ring-shaped second isolating unit 112.

FIG. 2a is a schematic diagram of an asymmetric half-bridge LLC circuit including the transformer 100, wherein (Lm) is the excitation inductance of the transformer 100 and (L1) is the leakage inductance of the primary winding 104. When a sinusoidal current (Ii) (such as the waveform 101 in FIG. 2d) is inputted into the transformer 100 at anode 15of the circuit, the circuit will output a rectified current (Io) (such as the waveform 103 in FIG. 2d). FIGS. 2b and 2c show two different working states of the asymmetric half-bridge LLC circuit, respectively. During a positive half-cycle of the waveform of the input current (Ii), a diode (D1) conducts, a diode (D2) is cutoff, and the primary winding induces a leakage inductance (Ls1). On the other hand, during a negative half-cycle of the waveform of the input current (Ii), the diode (D2) conducts, the diode (D1) is cutoff, and the primary winding induces a leakage inductance (Ls2). In theory, the values of the leakage inductances (Ls1) and (Ls2) should be close to each other in order for the circuit to work more efficiently and to reduce power loss.

Since the leakage inductance (L1) of the primary winding 104 of the transformer 100 will vary with the change in the input current (Ii), there is a relatively large difference between the values of the leakage inductances (Ls1) and (Ls2), which in turn results in non-uniform amplitude of the output current (Io), as evident from the waveform 103 in FIG. 2d. Due to the high and low peak values of the output current (Io), the circuit experiences larger power loss, thereby restricting applications of the transformer 100 and circuits employing the same.

FIG. 3 is a sectional diagram of another conventional center-tapped transformer 200, which includes a tubular spool 202, a primary winding 204, a first secondary winding 206, a second secondary winding 208, a first isolating unit 212, a second isolating unit 210, and an iron core (not shown). The spool 202 is formed with a hollow portion 214 for extension of the iron core therethrough. The primary winding 204 is wound on an upper section of the spool 202. The first secondary winding 206 is wound on a lower section of the spool 202 and is spaced apart from the primary winding 204 by the ring-shaped first isolating unit 212. The second secondary winding 208 is wound around the first secondary winding 206 and is spaced apart therefrom by the ring-shaped second isolating unit 210.

Compared to the transformer 100 of FIG. 1, the leakage inductance of the primary winding 204 of the transformer 200 is maintained at a certain level for different circuit working states, and the insulation distance between the primary winding 204 and the first and second secondary winding units 206, 208 has a positive effect on safety specifications. Nevertheless, the leakage inductance of the transformer 200 and circuits employing the same is relatively large, which restricts applications of the same.

It is apparent from the foregoing that the conventional center-tapped transformers 100, 200 either have non-uniform leakage inductance or a rather large leakage inductance, which results in large circuit power loss and restricts applications of the same.

### SUMMARY OF THE INVENTION

Therefore, the object of the present invention is to provide a center-tapped transformer that can overcome at least one of the abovementioned drawbacks of the prior art.

Accordingly, a center-tapped transformer of this invention comprises:

a first spool defining a spool axis and having an axially extending first spool part and a second spool part that extends coaxially from the first spool part;

a first primary winding unit surrounding the first and second spool parts;

first and second secondary winding units disposed on one side of the first primary winding unit and surrounding the first and second spool parts, respectively; and

a first isolating unit disposed between the first and second secondary winding units to separate the first and second secondary winding units from each other.

Preferably, the center-tapped transformer further comprises a second isolating unit disposed between said one side of the first primary winding unit and the first and second secondary winding units to separate the first primary winding unit from the first and second secondary winding units.

According to one embodiment, the first primary winding unit is disposed between the first spool and the first and second secondary winding units.

According to another embodiment, the first and second secondary winding units are disposed between the first spool and the first primary winding unit.

In view of the arrangement of the first and second secondary winding units, the first and second secondary winding units have the same positional relationship relative to the first primary winding unit. Accordingly, when the center-tapped transformer of this invention is applied to an asymmetric half-bridge LLC circuit, the leakage inductance of the first primary winding unit is maintained for different working states. In addition, through adjustment of the thickness of the first isolating unit, the leakage inductance of the first primary winding unit can be adjusted, thereby rendering the center-tapped transformer of this invention suitable for a wide range of applications.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional diagram of a conventional center-tapped transformer;

FIG. 2a is a circuit diagram of an asymmetric half-bridge LLC circuit including the transformer of FIG. 1;

FIGS. 2b and 2c show two different working states of the asymmetric half-bridge LLC circuit of FIG. 2a;

FIG. 2d illustrates input and output current waveforms in the asymmetric half-bridge LLC circuit of FIG. 2a;

FIG. 3 is a sectional diagram of another conventional center-tapped transformer;

FIG. 4a is a sectional diagram of the first preferred embodiment of a center-tapped transformer according to the present invention;

FIG. 4b is a circuit diagram of an asymmetric half-bridge LLC circuit including the first preferred embodiment;

FIG. 4c illustrates input and output current waveforms in the asymmetric half-bridge LLC circuit of FIG. 4b;

FIG. 5 is a sectional diagram of the second preferred embodiment of a center-tapped transformer according to the present invention;

FIG. 6 is a sectional diagram of the third preferred embodiment of a center-tapped transformer according to the present invention;

FIG. 7a is a partly exploded sectional diagram of the fourth preferred embodiment of a center-tapped transformer according to the present invention;

FIG. 7b is an assembled sectional diagram of the fourth preferred embodiment;

FIG. 8 is a partly exploded sectional diagram of the fifth preferred embodiment of a center-tapped transformer according to the present invention; and

FIGS. 9a and 9b are perspective views of two spools suitable for use in the sixth preferred embodiment of a center-tapped transformer according to the present invention.

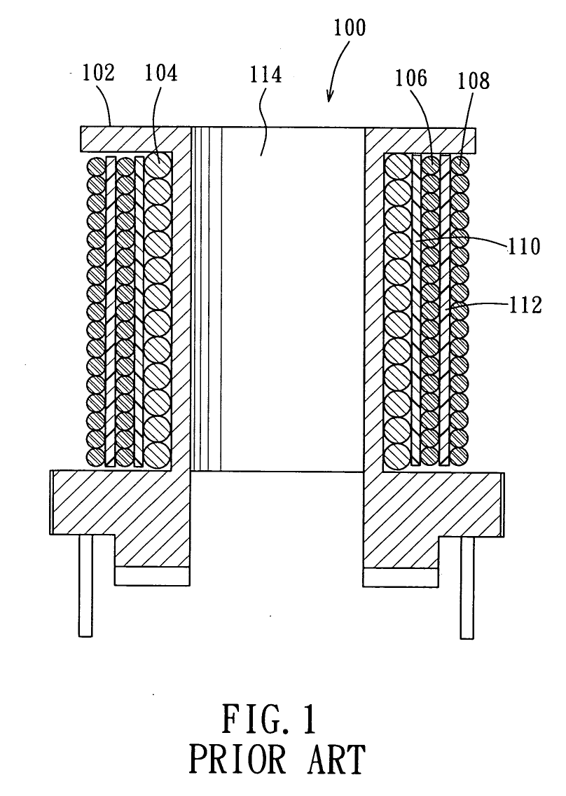

### DETAILED DESCRIPTION OF THE PREFERRED EMBODIMENTS

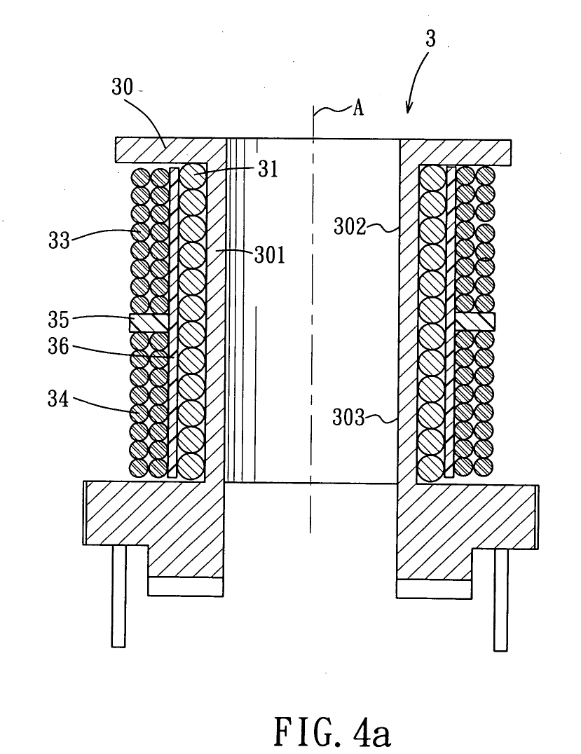

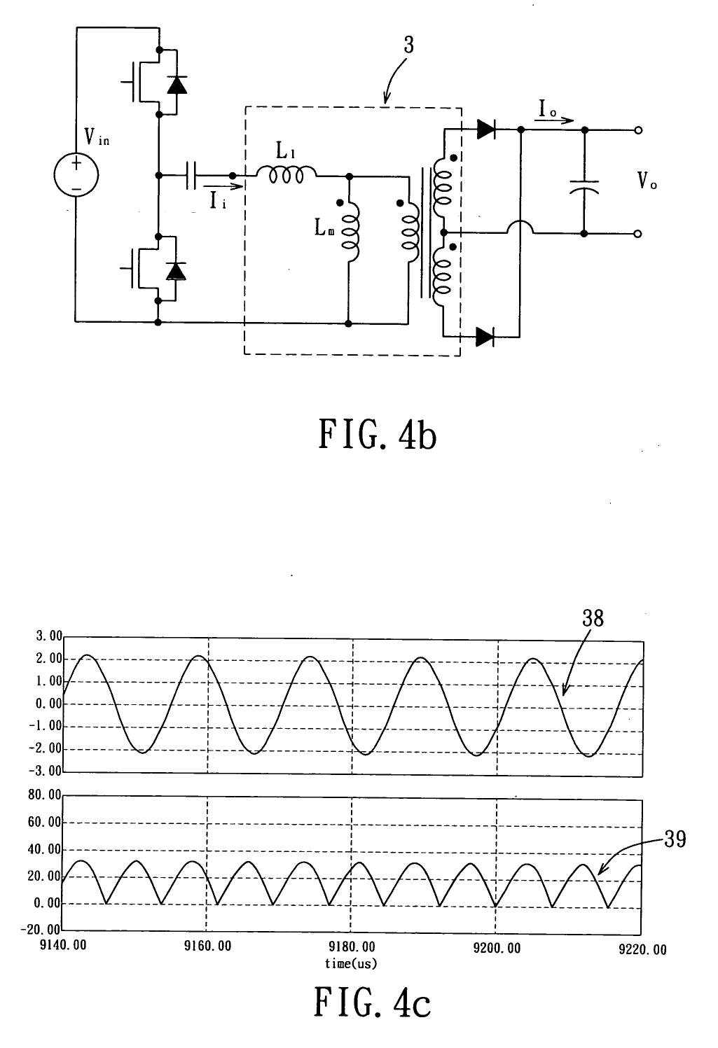

Referring to FIG. 4a, the first preferred embodiment of a center-tapped transformer 3 according to the present invention is shown to include a first spool 30, a first primary winding unit 31, a first secondary winding unit 33, a second secondary winding unit 34, a first isolating unit 35, a second isolating unit 36, and an iron core (not shown).

The first spool 30 has a surrounding wall 301 that defines a spool axis (A), and that has an axially extending first spool part 302 and a second spool part 303 extending coaxially from the first spool part 302.

The first primary winding unit 31 surrounds the first and second spool parts 302, 303 of the surrounding wall 301 of the first spool 30.

In this embodiment, the first and second secondary winding units 33, 34 are disposed on an outer side of the first primary winding unit 31 and surround the first and second spool parts 302, 303 of the surrounding wall 301 of the first spool 30, respectively.

The first isolating unit 35 is disposed between the first and second secondary winding units 33, 34 to separate the first and second secondary winding units 33, 34 from each other.

The second isolating unit 36 is disposed between the outer side of the first primary winding unit 31 and the first and second secondary winding units 33, 34 to separate the first primary winding unit 31 from the first and second secondary winding units 33, 34.

The iron core is to be extended into the surrounding wall 301 of the first spool 30, and can be any one of the following: EE type iron core, EC type iron core, EF type iron core, ER type iron core, PQ type iron core, EER type iron core, EFD type iron core, ERL type iron core and PM type iron core. Since the feature of this invention does not reside in the iron core, further details of the same are omitted herein for the sake of brevity.

In this embodiment, the second isolating unit 36 is tubular. The first isolating unit 35 surrounds a middle part of the second isolating unit 36 and is disposed transverse to an outer peripheral surface of the second isolating unit 36.

The first primary winding unit 31 is wound on an entire length of the surrounding wall 301 of the first spool 30. The tubular second isolating unit 36 is sleeved on the outer side of the first primary winding unit 31 such that the first primary winding unit 31 is confined between the surrounding wall 301 of the first spool 30 and the second isolating unit 36. The first secondary winding unit 33 and the second secondary winding unit 34 are coaxially disposed, are disposed side-by-side along the spool axis (A), and are wound on an outer side of the second isolating unit 36. In this embodiment, in order to obtain a more stable output current, the first and second secondary winding units 33, 34 are evenly and respectively wound on upper and lower portions of the second isolating unit 36 and are separated from each other by the first isolating unit 35. The first isolating unit 35 and the second isolating unit 36 can be an insulating tape or an insulating material such as plastic.

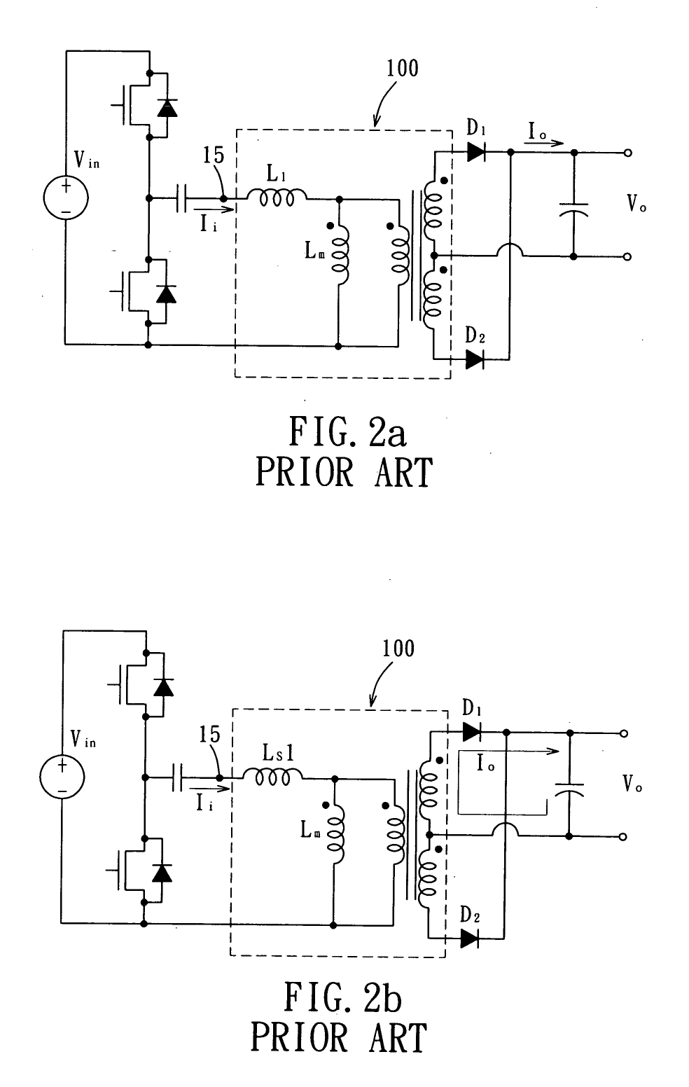

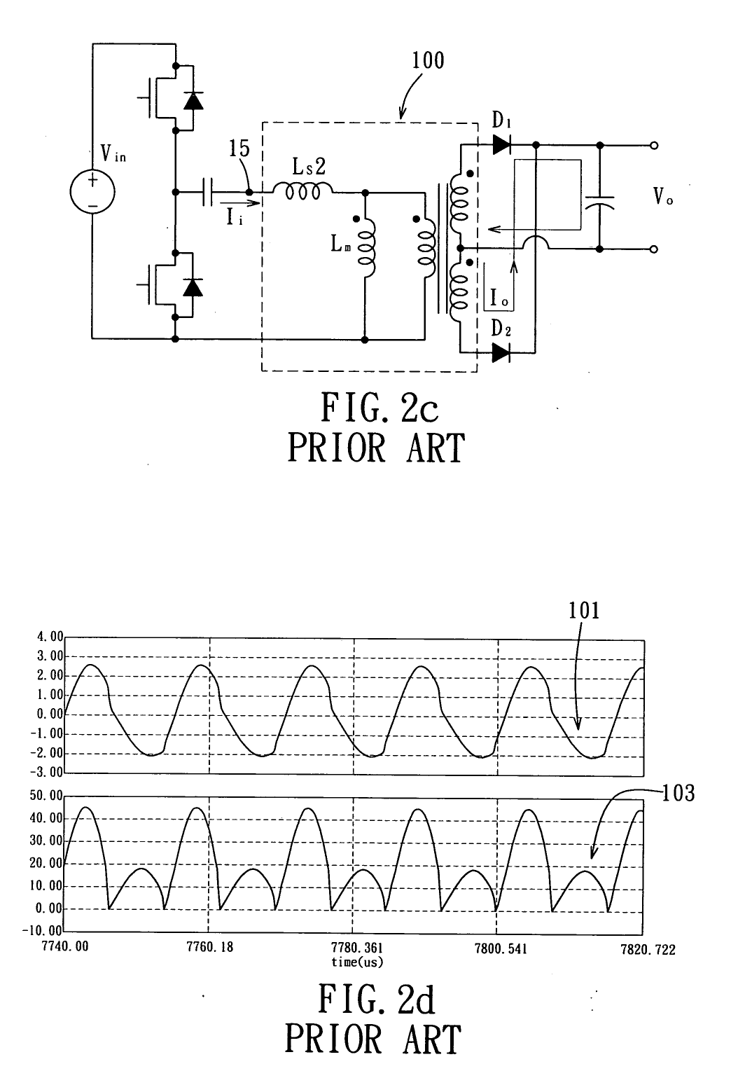

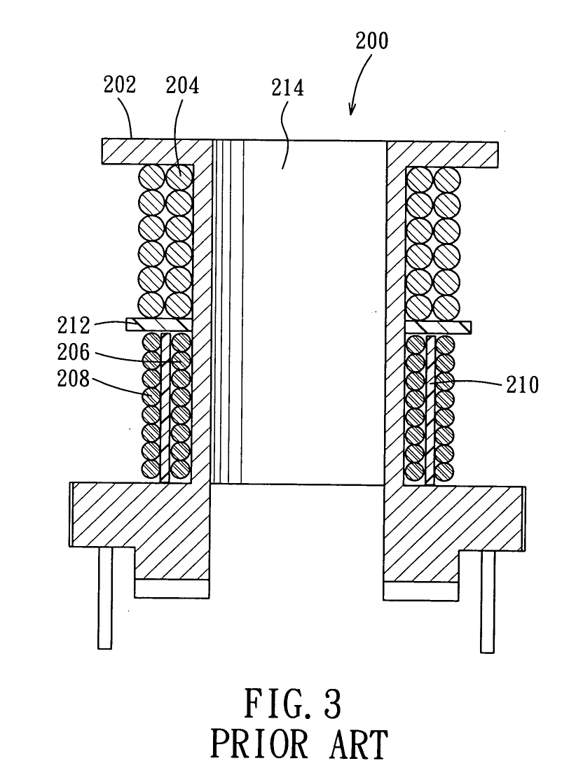

FIG. 4b is a circuit diagram of an asymmetric half-bridge LLC circuit including the first preferred embodiment. FIG. 4c illustrates waveforms of input and output currents in the asymmetric half-bridge LLC circuit of FIG. 4b. When a sinusoidal current (Ii) (such as the waveform 38 in FIG. 4c) is inputted into the transformer 3, compared to the waveform 101 in FIG. 2d, since the leakage inductance (L1) of the first primary winding unit 31 does not vary with changes in the input current (Ii), the waveform 38 of the resonant current (Ii) closely resembles a pure sinusoidal wave. In addition, peak values of the output current (Io) are uniform, and the waveform of the output current (Io) is continuous (see the waveform 39 in FIG. 4c). As such, power loss of the circuit including the transformer 3 is less, and efficiency is higher.

In the first preferred embodiment of this invention, apart from ensuring that the leakage inductance (L1) of the first primary winding unit 31 is maintained at a certain level under different working states, the thickness of the first isolating unit 35 can be adjusted according to a requirement of the circuit application, such that the distance between the first and second secondary winding units 33, 34 is adjusted so as to obtain the requisite leakage inductance. The center-tapped transformer 3 therefore has a wide range of applications.

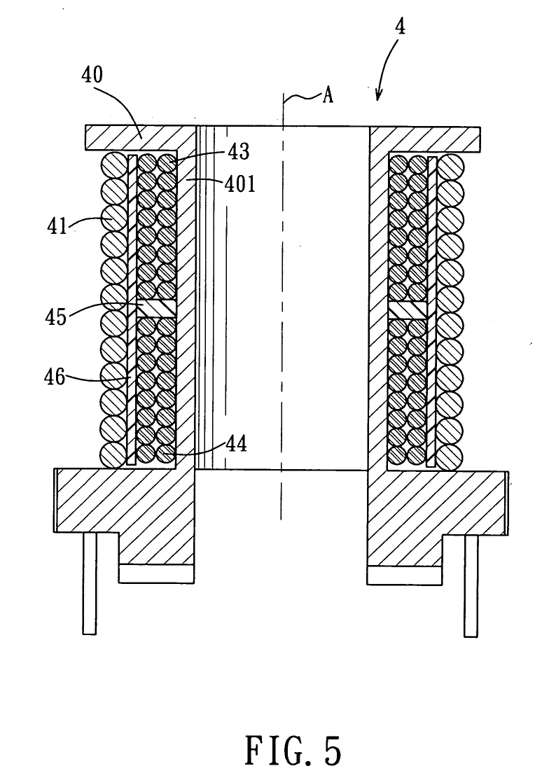

Referring to FIG. 5, the second preferred embodiment of a center-tapped transformer 4 according to this invention is shown to include a first spool 40, a first primary winding unit 41, a first secondary winding unit 43, a second secondary winding unit 44, a first isolating unit 45, a second isolating unit 46, and an iron core (not shown). In this embodiment, the first secondary winding unit 43 and the second secondary winding unit 44 are disposed between the first primary winding unit 41 and the surrounding wall 401 of the first spool 40, and are separated from each other by the first isolating unit 45, which surrounds a middle part of the surrounding wall 401 of the first spool 40 and is disposed transverse to an outer peripheral surface of the surrounding wall 401. The first secondary winding unit 43 and the second secondary winding unit 44 are coaxially disposed, are disposed side-by-side along the spool axis (A) defined by the surrounding wall 401, and are wound on the surrounding wall 401. The tubular second isolating unit 46 is sleeved on outer sides of the first and second secondary winding units 43, 44 such that the first and second secondary winding units 43, 44 are confined between the surrounding wall 401 of the first spool 40 and the second isolating unit 46. The first primary winding unit 41 is wound on an entire length of the second isolating unit 46.

Like the first preferred embodiment, the leakage inductance of the first primary winding unit 41 is maintained at a certain level under different working states, and the thickness of the first isolating unit 45 can be adjusted according to the leakage inductance required by a circuit application.

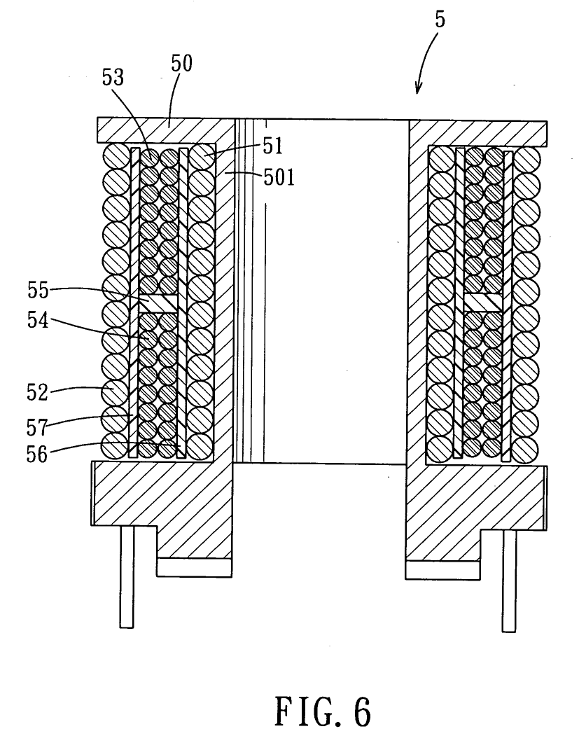

Referring to FIG. 6, the third preferred embodiment of a center-tapped transformer 5 according to this invention is shown to include a first spool 50, a first primary winding unit 51, a first secondary winding unit 53, a second secondary winding unit 54, a first isolating unit 55, a second isolating unit 56, and an iron core (not shown). Compared to the first preferred embodiment, this embodiment further includes a second primary winding unit 52 surrounding the first and second secondary winding units 53, 54, and a tubular third isolating unit 57 disposed between the first and second secondary winding units 53, 54 and the second primary winding unit 52 to separate the second primary winding unit 52 from the first and second secondary winding units 53, 54. The second primary winding unit 52 is wound on the third isolating unit 57. Like the first and second preferred embodiments, the leakage inductance of the first primary winding unit 51 is maintained at a certain level under different working states, and the thickness of the first isolating unit 55 can be adjusted according to the leakage inductance required by a circuit application.

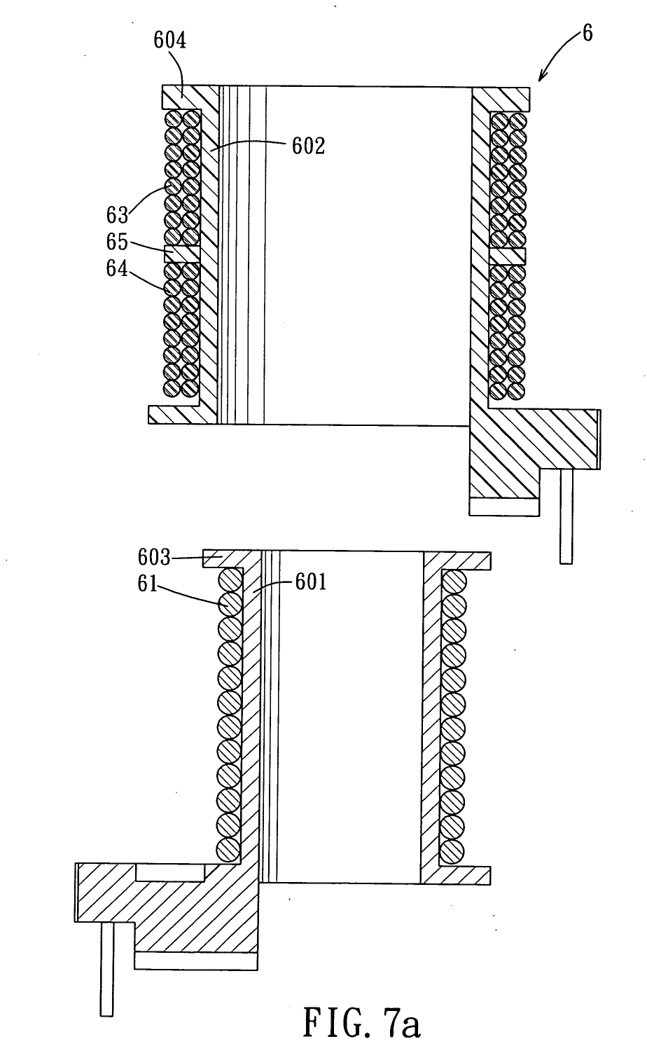

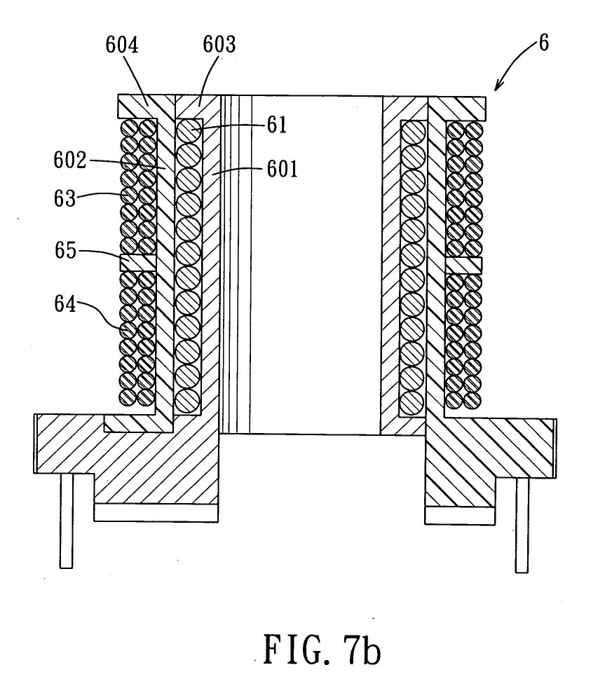

Referring to FIG. 7a, the fourth preferred embodiment of a center-tapped transformer 6 according to this invention is shown to include a first spool 603 having a surrounding wall 601, and a second spool 604 having a tubular second isolating unit 602 that permits insertion of the first spool 603 therein. A first isolating unit 65 surrounds a middle part of the second isolating unit 602 and is disposed transverse to an outer peripheral surface of the second isolating unit 602. A first primary winding unit 61 is wound on an entire length of the surrounding wall 601 of the first spool 603. A first secondary winding unit 63 and a second secondary winding unit 64 are wound evenly and respectively on upper and lower portions of the second isolating unit 602, and are separated from each other by the first isolating unit 65.

In this embodiment, after winding the first and second secondary winding units 63, 64 on the second spool 604, and winding the first primary winding unit 61 on the first spool 603, the assembly of the first primary winding unit 61 and the first spool 603 is inserted into the second spool 604, as best shown in FIG. 7b. At this time, the first primary winding unit 61 is confined between the second isolating unit 602 and the surrounding wall 601 of the first spool 603, and the first and second secondary winding units 63, 64 are respectively wound on upper and lower portions of the second isolating unit 602. In this manner, the manufacturing process of the center-tapped transformer 6 is simplified, and the manufacturing time is shortened.

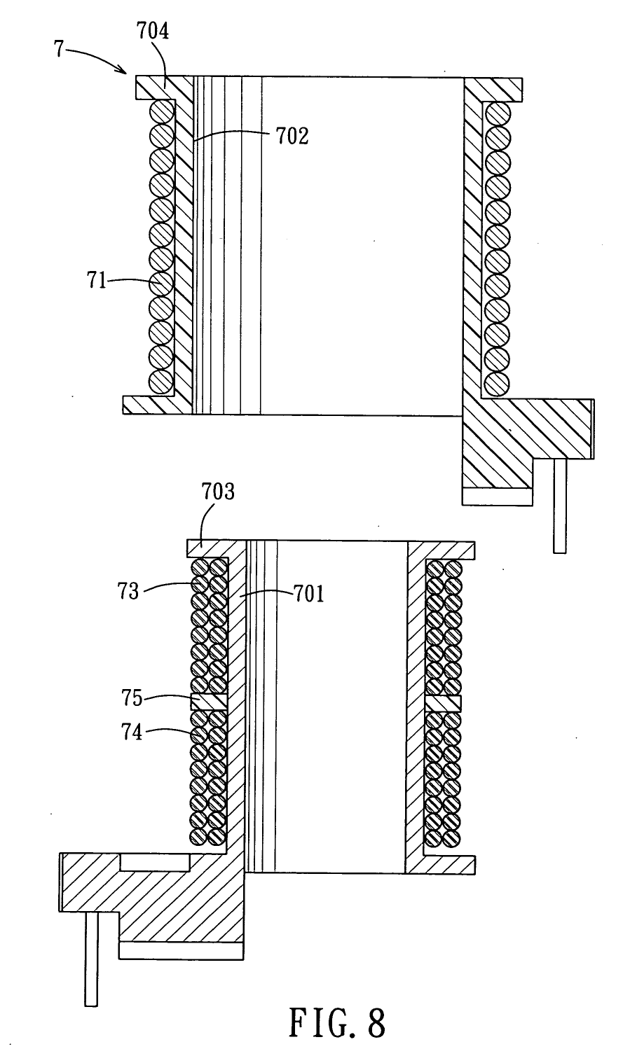

Referring to FIG. 8, the fifth preferred embodiment of a center-tapped transformer 7 according to this invention is shown to include a first spool 703 having a surrounding wall 701, and a second spool 704 having a tubular second isolating unit 702 that permits insertion of the first spool 703 therein. Unlike the fourth preferred embodiment, a first isolating unit 75 surrounds a middle part of the surrounding wall 701 of the first spool 703 and is disposed transverse to an outer peripheral surface of the surrounding wall 701. A first primary winding unit 71 is wound on an entire length of the second isolating unit 702. A first secondary winding unit 73 and a second secondary winding unit 74 are wound evenly and respectively on upper and lower portions of the surrounding wall 701 of the first spool 703, and are separated from each other by the first isolating unit 75. Since the first and second spools 703, 704 can be coupled together in a manner similar to that in the fourth preferred embodiment, the advantages of the fourth preferred embodiment are likewise achieved by the fifth preferred embodiment.

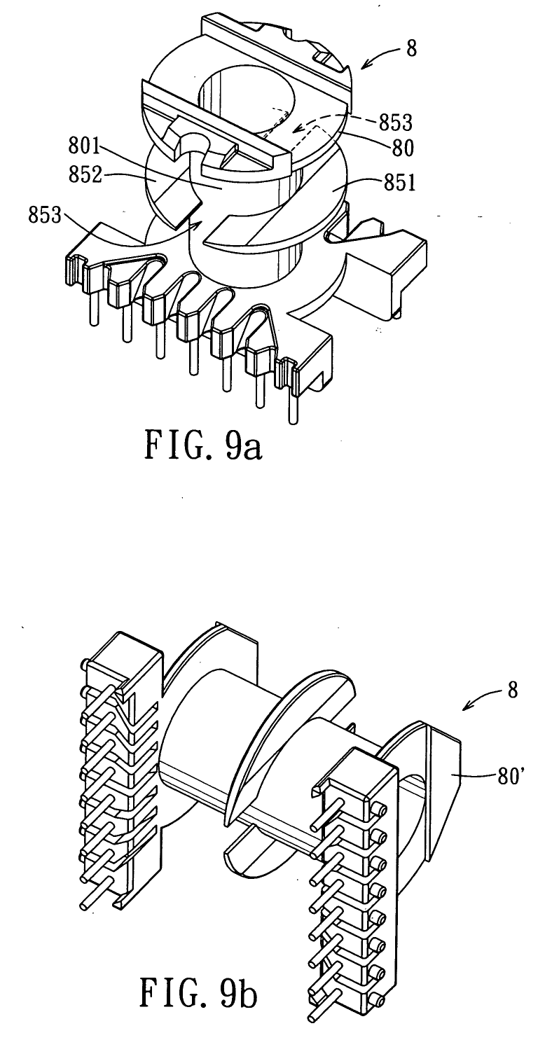

Referring to FIGS. 9a and 9b, the sixth preferred embodiment of a center-tapped transformer 8 according to this invention is shown to differ from the second preferred embodiment in that the first isolating unit includes first and second plates 851, 852 that lie on a plane transverse to a spool axis defined by a surrounding wall 801 of the first spool 80, 80′. The first and second plates 851, 852 cooperate with the surrounding wall 801 of the first spool 80, 80′ to define a pair of notches 853 adapted for passage of conductive wires (not shown) of the first primary winding unit so that the latter is able to wind around the entire length of the surrounding wall 801 without being restricted by the first isolating unit. FIG. 9a illustrates an upright spool 80, whereas FIG. 9b illustrates a horizontal spool 80′. Depending on requirements, either one of the spools 80, 80′ may be selected for use in the center-tapped transformer 8.

Some of the advantages of this invention are summarized below:

1. Taking the embodiment of FIG. 4a as an example, since the first and second secondary winding units 33, 34 have the same positional relationship relative to the first primary winding unit 31 and the iron core (not shown) in the first spool 30, when a sinusoidal current is inputted into the first primary winding unit 31, the leakage inductance is maintained at a certain level under different circuit working states.

2. Taking the embodiment of FIG. 5 as an example, through adjustment of the thickness of the first isolating unit 45 that separates the first and second secondary winding units 43, 44 from each other, the leakage inductance of the first primary winding unit 41 is adjusted, thereby rendering the center-tapped transformer of this invention suitable for a wide range of applications.

3. By using the leakage inductance of the center-tapped transformer of this invention for resonance inductance of transformers of LLC type, LC type, etc., additional inductors to serve as resonance inductance are not needed, thereby reducing transformer power loss and saving space.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A center-tapped transformer comprising:
a first spool defining a spool axis and having an axially extending first spool part and a second spool part that extends coaxially from said first spool part;
a first primary winding unit surrounding said first and second spool parts;
first and second secondary winding units disposed on one side of said first primary winding unit and surrounding said first and second spool parts, respectively; and
a first isolating unit disposed between said first and second secondary winding units to separate said first and second secondary winding units from each other.

2. The center-tapped transformer as claimed in claim 1, further comprising a second isolating unit disposed between said one side of said first primary winding unit and said first and second secondary winding units to separate said first primary winding unit from said first and second secondary winding units.

3. The center-tapped transformer as claimed in claim 1, wherein said first primary winding unit is disposed between said first spool and said first and second secondary winding units.

4. The center-tapped transformer as claimed in claim 1, wherein said first and second secondary winding units are disposed between said first spool and said first primary winding unit.

5. The center-tapped transformer as claimed in claim 4, wherein said first isolating unit includes first and second plates that lie on a plane transverse to the spool axis.

6. The center-tapped transformer as claimed in claim 5, wherein said first and second plates cooperate with said first spool to define a pair of notches adapted for passage of conductive wires.

7. The center-tapped transformer as claimed in claim 1, wherein said first primary winding unit is disposed between said first spool and said first and second secondary winding units, said center-tapped transformer further comprising a second primary winding unit surrounding said first and second secondary winding units.

8. The center-tapped transformer as claimed in claim 7, further comprising:
a second isolating unit disposed between said one side of said first primary winding unit and said first and second secondary winding units to separate said first primary winding unit from said first and second secondary winding units; and
a third isolating unit disposed between said first and second secondary winding units and said second primary winding unit to separate said second primary winding unit from said first and second secondary winding units.

9. The center-tapped transformer as claimed in claim 1, further comprising a tubular second spool, one of said first primary winding unit and said first and second secondary winding units being provided on said first spool, the other of said first primary winding unit and said first and second secondary winding units being provided on said second spool, an assembly of said first spool and said one of said first primary winding unit and said first and second secondary winding units being inserted into said second spool.
